(19) United States
(12) Patent Application Publication
(10) Pub. No.: US 2007/0194901 A1
(43) Pub. Date: Aug. 23, 2007

(54) Linear Indicator

(76) Inventors: Wolfgang Ziegler, Karlsbad (DE); Atanas Salabaschew, Paris (FR)

Correspondence Address: FOLEY & LARDNER LLP, 777 EAST WISCONSIN AVENUE, MILWAUKEE, WI, 53202-5306, US

(21) Appl. No.: 10/559,492

(22) PCT Filed: Jun. 4, 2004
(86) PCT No.: PCT/EP04/06050

§ 371 Date: Apr. 5, 2007

(30) Foreign Application Priority Data
Jun. 5, 2003 (DE) 103 25 793.4

(51) Int. Cl. B60Q 1/00

(52) U.S. Cl. 340/461

(57) ABSTRACT

The invention relates to an analog display instrument, in particular for use in motor-vehicle dashboards. The display instrument includes an indicator configured to move in front of a scale, a guide in the form of one of a straight line and a curve, and an electrically controllable drive configured to move the indicator along the guide. The indicator is movable linearly along the guide in forward and backwards directions by the electrically controllable drive.

### CROSS-REFERENCE TO RELATED PATENT APPLICATIONS

The present Application claims the benefit of priority to the following international Applications: PCT patent application No. PCT/EP2004/006050 entitled “Linear Indicator” filed on Jun. 4, 2004 which published under PCT Article 21(2) on Dec. 16, 2004 as WO 2004/109233 A2 and WO 2004/109233 A3 in the German language and German Patent Application No. DE 103 25 793.4 on Jun. 5, 2003, which are hereby incorporated by reference herein in their entirety.

### BACKGROUND

The present invention relates to an analog display instrument, in particular for use in motor-vehicle dashboards, with the instrument having an indicator which moves in front of a scale.

A large variety of indicator instruments of this type have long been known. An indicator is usually moved around a circle or a segment of a circle, with the indicator being held at the top of a shaft which is driven by a stepper motor. The movement of the indicator is therefore restricted to a corresponding circular path. This enforced circular movement considerably restricts possible designs when developing such instruments. The installation space and specifically, the area required on the display panelare relatively large, with the result that limits are set on the miniaturization of the instruments to maintain readability. A high degree of outlay in terms of design is also needed if, in order to save space, a plurality of displays equipped with indicators are to be arranged such that their angular regions overlap.

In addition to these circular displays, instruments whose indicators are formed by an arrow whose length changes and which extend linearly along a scale are known from the vehicle industry. This solution was not successful on account of the high technical outlay required for mimetic adjustment and the associated increase in the susceptibility of the instruments to faults.

It would be advantageous to provide an analog display instrument which can be matched to any desired design requirements in a flexible manner, can be implemented in a cost-effective manner using simple means, and enables information to be read off exactly.

Another advantage of the present linear indicator is that it enables flexibility of design of the scale which can now be arranged in any desired curves on the dashboard. The present linear indicator makes it possible to match the analog instruments to the conditions on the display panel and thus divide up the available space effectively. In addition, the ability to see the instruments can be increased by the deliberate use of optical effects when designing said instruments. Another advantage is that the invention provides a high degree of scope for particularly unusual design features which can be matched to the style of the respective type of vehicle. The instruments according to the invention can be implemented in a comparatively cost-effective manner using the means which are commercially available nowadays.

### SUMMARY

In accordance with an embodiment, an analog display instrument, for use in motor-vehicle dashboards includes an indicator configured to move in front of a scale, a guide in the form of one of a straight line and a curve, and an electrically controllable drive configured to move the indicator along the guide, where the indicator is movable linearly along the guide in forward and backwards directions by the electrically controllable drive.

In accordance with another embodiment, an analog display instrument for use in motor-vehicle dashboards includes an indicator configured to move in front of a scale, a guide in the form of one of a straight line and a curve, and an electrically controllable drive configured to move the indicator along the guide, where the indicator is movable linearly along the guide in forward and backwards directions by the electrically controllable drive, the indicator is arranged on a slide which is positively guided along the guide, the indicator can be moved directly by the drive which is seated on the slide, and the position of one of the slide and the indicator, in relation to the guide and therefore in relation to the scale, can be established using a sensor system.

In accordance with another embodiment, an analog display instrument, for use in motor-vehicle dashboards includes an indicator configured to move in front of a scale, a guide in the form of one of a straight line and a curve, an electrically controllable drive configured to move the indicator along the guide, the indicator movable linearly along the guide in forward and backwards directions by the electrically controllable drive, and a control loop which forwards an actual position of the indicator to a controller as an input variable, the controller compares a prespecified desired position with the actual position of the indicator to determine a control difference and the controller forwards the control difference to the drive as an output variable.

### BRIEF DESCRIPTION OF THE DRAWINGS

This invention will be understood more clearly with reference to the following description and the appended drawings, in which:

FIG. 1 is a schematic illustration of an instrument according to n embodiment.

FIG. 2 is another schematic illustration of the instrument according to an embodiment.

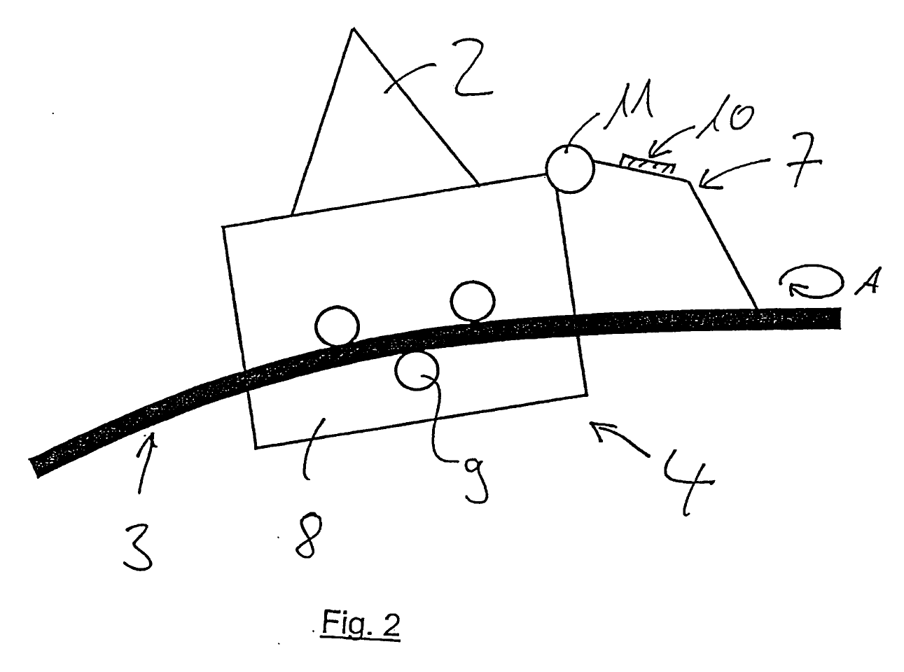

### DETAILED DESCRIPTION

In the FIGURES, identical parts are provided with the same reference numbers and they are generally also only described once in each exemplary embodiment.

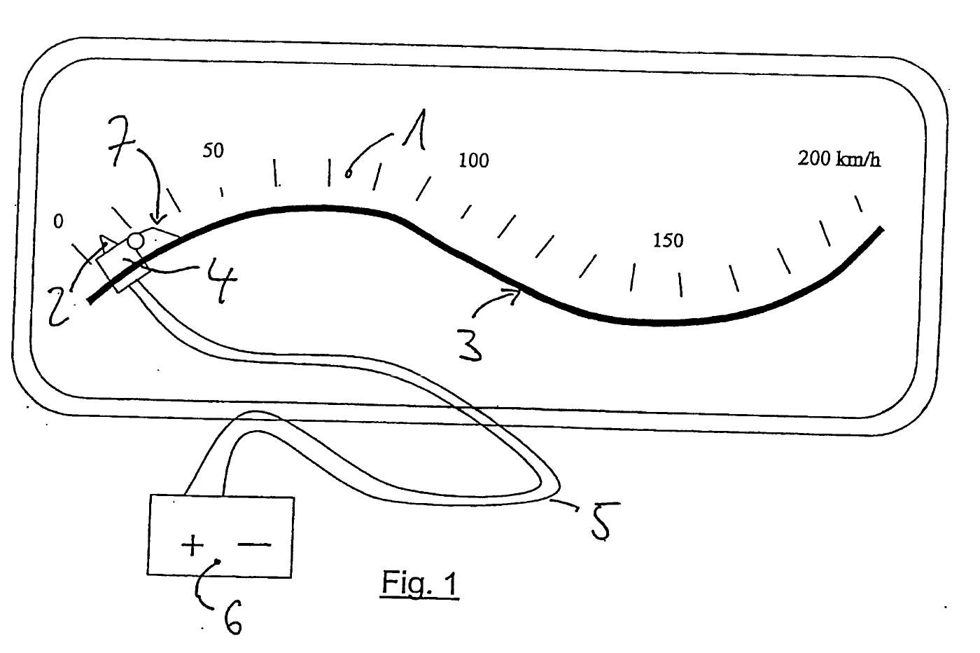

FIG. 1 illustrates an instrument for displaying speed which can be used in motor-vehicle dashboards. The instrument has an indicator 2 which moves in front of a scale 1 and can be illuminated in a known manner. The instrument has a guide 3 which is in the form of a shaft, it being possible for the indicator 2 to be moved linearly along the guide in the forward and backward directions by an electrically controllable drive 4. The drive 4 is connected to a power source 6 via thin wires 5. In this case, the drive is a piezomotor which moves along the fixed and guide 3, with a drive part 7 of the piezomotor engaging on the guide 3 in a non-positive manner. In this embodiment, the piezomotor has a slide 8 which is positively guided along the guide 3 using rollers 9. The guide 3 is formed by a rod which is composed of plastic interspersed with carbon and on which the piezomotor is seated, with the piezomotor having a drive part with a vibration element 7 which engages on the rod 3 and whose tip is excited so as to produce elliptical movements (arrow A) and thus push off from the rod 3. A piezoceramic 10 is fitted on the vibration element 7 and is excited by an applied AC voltage. The vibration element 7 is held on the slide 8 by means of a spring 11.

The central idea of the invention is to move the indicator linearly in front of the scale. This movement takes place along a guide which is in the form of a straight line or a curve depending on the respective requirement. In this case, the curve may be of any desired shape, for example can also assume the shape of an arc of a circle. However, it is advantageous if the curve is continuous and does not have any kinks.

The indicator, or the slide on which the indicator is seated, is made to move in both movement directions by an electrically controllable drive. This drive may drive the indicator or the slide either directly or indirectly. Direct driving may be performed by a motor which is directly connected to the indicator. A motorized slide of this type which is fitted with an indicator would then move along the guide, it being possible for the guide to be in the form of a rail. Indirect driving may be performed by a fixed motor which moves the slide along the guide with the aid of transmission means, such as cable pulls or flexible shafts.

Even when it is possible to use an indirect drive of this type to move an indicator along curved, wavy or looped curves by means of a corresponding guide in a positively guided manner, it is particularly advantageous when the indicator is arranged on a slide which is positively guided along the guide and can be moved directly by a drive which is likewise seated on the slide. A slide of this type then moves with its own drive along the guide. The slide is controlled in each case as a function of the measured variable which is to be shown by the instrument. Therefore, the distance travelled by the slide, the distance it covers from a zero point, corresponds to the current speed of the vehicle, for example.

The motor which drives the slide may be a conventional stepper motor. If this motor is seated on the slide, it can move along a guide which is equipped with teeth. The position of the indicator is then determined by means of the number of steps made and counted by the motor.

However, in order to minimize the outlay on design, it is particularly advantageous when the drive, which in particular is seated on the slide, is a linear drive. A linear drive of this type can make the slide move linearly on the guide without further components, such as gear mechanisms. In this case, various types of linear drives, in particular AC and DC linear motors, are known. However, on account of the particular potential for further miniaturization and on account of the advanced developments, linear drives with a piezomotor are preferred, with this piezomotor moving along the fixed guide which is in the form of a rod, in particular. In this case, a drive part of the piezomotor engages on the guide in a non-positive manner. A particularly simple embodiment of the piezomotor is seated displaceably on the rod and moves with the aid of a vibration element which is excited so as to produce elliptical movements and is part of the drive element. The slide can be displaced at any desired speed with a drive of this type.

One potential problem with the linear drives, in particular the said piezomotors, is that typically the distance covered can only be reproduced within certain limits. If a piezomotor of this type makes a specific number of steps in one direction, there is no guarantee that the same number of steps in the other direction will lead precisely to the same starting point. For this reason, it is advantageous to provide a sensor system which is independent of the piezomotor and which can be used to observe the current position of the slide. In one advantageous embodiment of the invention, the indicator position in relation to the guide and/or in relation to the scale can therefore be established using the sensor system. The variables obtained by means of the sensor system are advantageously used as the basis of a control process.

Due to the simple and cost-effective design and the accuracy of the determined variables, it is advantageous to form a voltage divider circuit with the slide which is fitted with the indicator. To this end, an electrically conductive track with the most homogeneous resistance possible is advantageously fitted along the rod, on which track a current collector which is fitted on the slide rests. If a maximum voltage is now applied over a distance of the track, in particular between the starting position (zero position) and a maximum position of the slide, a partial voltage can be tapped off across the current collector. In one particularly simple and robust embodiment, the entire rod is produced from conductive material with a defined resistance, in particular from a plastic interspersed with carbon. In another variant, the rod may also be surrounded by a winding on whose stripped surface the current collector can be displaced.

The voltage divider circuit is advantageously formed in such a way that the ends of the track travelled by the slide and the tap of the current collector are connected to form a measuring bridge. The position of the current collector on the track can be determined from the ratio of the voltages. The actual position of the indicator in relation to the scale can be determined from the position of the current collector. In this case, it is advantageous to provide a control loop which forwards the actual position of the indicator to a controller as an input variable which said controller compares with a prespecified desired position, with the controller forwarding the control difference to the piezomotor as an output variable. The desired position is determined from the measured variable, for example the measured speed.

In general, the analog values can be converted by means of an analog/digital converter (ADC) and processed in a microprocessor. In this way, the indicator position can be reliably calculated, it being possible to adjust the accuracy of the calculation by means of the resolution of the ADC used.

In order to be able to reproduce the positioning of the piezomotor, the desired and actual positions can also be adjusted by means of a circuit for adjusting the zero point in a simple embodiment. This circuit performs the adjustment, for example, when the indicator is in its starting position. Adjustment of this type may replace the control process or else be provided in addition to the control process.

It is possible to use the vibration element which is in contact with the track as the current collector. This simplification obviates the need for an additional component, and this contributes to increasing the reliability of the instrument and saving costs.

It should be understood that the construction and arrangement of the elements of the display device in the exemplary embodiments are illustrative only. Although only a few embodiments of the present invention have been described in detail in this disclosure, many modifications are possible without materially departing from the novel teachings and advantages of the subject matter recited in the claims. For example, the temperature sensing device may be adapted for use in other systems or locations, may incorporate additional temperature sensors or other inputs, or may include other variables or factors in the extrapolation function. Accordingly, all such modifications are intended to be included within the scope of the present invention as defined in the appended claims. Unless specifically otherwise noted, the claims reciting a single particular element also encompass a plurality of such particular elements. Moreover, claims reciting that one element is coupled to another should be interpreted to mean that the elements are selectively coupled to each other and may be uncoupled or disconnected at any point. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and/or omissions may be made in the design, operating conditions and arrangement of the preferred and other exemplary embodiments without departing from the spirit of the present invention as expressed in the appended claims.

1-12. (canceled)

13. An analog display instrument, in particular for use in motor-vehicle dashboards, comprising:
an indicator configured to move in front of a scale;
a guide in the form of one of a straight line and a curve; and
an electrically controllable drive configured to move the indicator along the guide;
wherein the indicator is movable linearly along the guide in forward and backwards directions by the electrically controllable drive.

14. The instrument of claim 13, wherein the indicator is arranged on a slide which is positively guided along the guide and wherein the indicator can be moved directly by the drive which is seated on the slide.

15. The instrument of claim 14, wherein the drive is a linear drive.

16. The instrument of claim 15, wherein the linear drive is a piezomotor and the guide is fixed, the piezomotor configured to move along the guide and comprising a drive part engaging the guide in a non-positive manner.

17. The instrument of claim 16, wherein the guide is a rod on which the piezomotor is seated and wherein the piezomotor comprises a drive part with a vibration element that engages on the rod and pushes off from the rod based on elliptical movements.

18. The instrument of claim 17, wherein the position of one of the slide and the indicator in relation to the guide and therefore in relation to the scale is established using a sensor system.

19. The instrument of claim 18, further comprising:
an electrically conductive track with a homogeneous resistance provided along the guide; and
a current collector of the slide which rests on the electrically conductive track, wherein a maximum voltage is applied over the length of the track between a starting position and a maximum position of the slide;
wherein the current collector is configured so that a partial voltage may be tapped off across the current collector.

20. The instrument of claim 19, wherein the current is tapped across the vibration element which is configured to be in contact with the electrically conductive track.

21. The instrument as claimed in claim 19, wherein the electrically conductive track comprises ends of the track and wherein the ends of the electrically conductive track and the tap off of partial voltage across the current collector are connected by the current collector in a manner to create a measuring bridge which can be used to calculate the position of the current collector with respect to the electrically conductive track and the actual position of the indicator with respect to the scale.

22. The instrument of claim 21, further comprising:
a control loop which forwards the actual position of the indicator to a controller as an input variable and wherein the controller compares a prespecified desired position with the actual position of the indicator to determine a control difference and the controller forwards the control difference to the piezomotor as an output variable.

23. The instrument of claim 22, further comprising a circuit for adjusting a zero point, wherein the circuit performs an adjustment when the indicator is in a starting position.

24. The instrument of claim 23, wherein the guide is composed of a conductive plastic material provided with carbon.

25. An analog display instrument, in particular for use in motor-vehicle dashboards, comprising:
an indicator configured to move in front of a scale;
a guide in the form of one of a straight line and a curve; and
an electrically controllable drive configured to move the indicator along the guide;
wherein the indicator is movable linearly along the guide in forward and backwards directions by the electrically controllable drive;
wherein the indicator is arranged on a slide which is positively guided along the guide and the indicator can be moved directly by the drive which is seated on the slide; and
wherein the position of one of the slide and the indicator in relation to the guide and therefore in relation to the scale can be established using a sensor system.

26. The instrument of claim 25, further comprising:
an electrically conductive track with a homogeneous resistance provided along the guide; and
a current collector of the slide which rests on the electrically conductive track, wherein a maximum voltage is applied over the length of the track between a starting position and a maximum position of the slide;
wherein the current collector is configured so that a partial voltage may be tapped off across the current collector.

27. The instrument of claim 26, wherein the drive is a piezomotor and the guide is fixed, the piezomotor configured to move along the guide and comprising a drive part engaging the guide in a non-positive manner.

28. The instrument of claim 27, wherein the guide is a rod on which the piezomotor is seated and wherein the piezomotor comprises a drive part with a vibration element, that engages on the rod and pushes off from the rod based on elliptical movements.

29. An analog display instrument, in particular for use in motor-vehicle dashboards, comprising:
an indicator configured to move in front of a scale;
a guide in the form of one of a straight line and a curve; and
an electrically controllable drive configured to move the indicator along the guide, wherein the indicator is movable linearly along the guide in forward and backwards directions by the electrically controllable drive; and
a control loop which forwards an actual position of the indicator to a controller as an input variable, wherein the controller compares a prespecified desired position with the actual position of the indicator to determine a control difference and the controller forwards the control difference to the drive as an output variable.

30. The instrument of claim 29, further comprising a circuit for adjusting a zero point, wherein the circuit performs an adjustment when the indicator is in a starting position.

31. The instrument of claim 30, wherein the guide is composed of a conductive plastic provided with carbon.

32. The instrument of claim 31, wherein the drive is a piezomotor and the guide is fixed, the piezomotor configured to move along the guide and comprising a drive part engaging the guide in a non-positive manner;
wherein the guide is a rod on which the piezomotor is seated; and
wherein the piezomotor comprises a drive part with a vibration element that engages on the rod and pushes off from the rod based on elliptical movements.
